(19) United States
(12) Patent Application Publication
(10) Pub. No.: US 2005/0216446 A1
(43) Pub. Date: Sep. 29, 2005

(54) Technical process to deliver pre-populated search suggestions using the intelli-match search methodology

(76) Inventor: Karl E. Hall, Lewisville, TX (US)

Correspondence Address: Karl E. Hall, Suite 200D, 4341 Lindbergh Dr., Addison, TX, 75001, US

(21) Appl. No.: 10/811,364

(22) Filed: Mar. 29, 2004

(51) Int. Cl. G06F 7/00

(52) U.S. Cl. 707/3

(57) ABSTRACT

This document proposes a technical process to deliver pre-populated search suggestions to search engine search boxes using the Intelli-Match search methodology The Intelli-Match process matches search activities to broad category databases in order present users with search engine keywords that are relevant to the user's general area of interest.

### BACKGROUND OF INVENTION

Most search engines use complex algorithms to rank web sites on their search results pages. These algorithms differ from search engine to search engine and are based on several different search models. However, there has been limited development activity related to the user experience at the time the user begins a search. Most search engines provide an empty search box on its search page; this puts all the responsibility on the user to enter keywords that relate to their interests. This method makes search more of a chore for the user rather than positioning search as an entertainment product. This patent presents an alternative method of searching the Internet with the objective of improving the consumer experience at the time the user makes the search decision by systematically offering relevant keywords for users.

This document outlines a technical process to deliver pre-populated keywords in search boxes using the Intelli-Match methodology. The process attempts to gauge the user's interest based on search history and provides prescreened suggestions (keywords) based on targeted interest categories.

### DETAILED DESCRIPTION

Definitions

Cookies—Small files placed on user's computers that contain information about the user.

Database—A controlled group of data elements housed in the same location that can be easily searched.

Hyperlink—Text or an image link on a web page that has a web address attached to it. The user goes to the associated web address if the user clicks on the text or image link.

Keyword(s)—A word or phrase entered into search form used to identify relevant web sites. Also called search terms.

Search—he act of entering keywords or phrases into a search form (search box), which in turn queries a database for web site listings presented on a search results page. Search Box The text area with a search form where keywords are entered.

Search Engine—Web sites on the Internet the query a database of web site links to generate relevant search results.

Search Results—A file or group of files containing web site key information such as web site title, meta tag, text on page, hyperlinks, ranking criteria, advertising deposits, etc.

### BACKGROUND

Most search engines use complex algorithms to rank web sites on their search results pages. These algorithms differ from search engine to search engine and are based on several different search models. However, there has been limited development activity related to the user experience at the time the user begins a search. Most search engines provide an empty search box on its search page; this puts all the responsibility on the user to enter keywords that relate to their interests. This method makes search more of a chore for the user rather than positioning search as an entertainment product. This patent presents an alternative method of searching the Internet with the objective of improving the consumer experience at the time the user makes the search decision by systematically offering relevant keywords for users.

Introduction This document proposes outlines a technical process to deliver pre-populated search suggestions using the Intelli-Match methodology. The process attempts to gauge the user's interest based on previous search history and provides prescreened suggestions based on targeted interest categories. This search process can be executed using personal computers, servers, mini or mainframe computers or through a standalone computer apparatus.

Note: This process does not in any way track user search activity on the search engine's computer system.

Database Format

This process may be applied to the following formats:
SQL;
MYSQL;
Oracle;
GigaBASE;
FastDB;
Informix
SE;
SYBase

Other databases capable of performing processes outlined within this document.

This process can also apply to future versions, releases and updates to the above formats.

Operating Platforms

The process can be executed using the following operating platforms.
Microsoft Windows;
Microsoft Servers;
Unix;
Linux;
Apple Operating Systems; and
Other server, mainframe and personal computer operating platforms.

This process can be applied to future versions, releases and similar operating platforms.

Applicable Uses of Search Technology

This process can be applied to the following types of searches:
Internet Searches;
Intranet Searches;
Business listings;
Private/Corporate Directories;
Real Estate Listings;
Music and Movie Catalogs; and
Magazines and Articles.

Programming Languages

This process can be programmed in the following computer programming languages:
C, C+ and C++;
Pascal and Turbo Pascal;
Java;
JavaScript;
PHP;
Fortran;
SQL:
MYSQL;
CGI/Perl; and
Other programming languages capable of performing processes outlined within this document.

Intelli-Match Process

The following are steps in the Intelli-Match process to pre-populate interesting keywords in the search engine search box.

Step 1.

Develop broad public category databases (“Dataset 1”=7 very simple category databases) in which to organize keywords.

Step 2.

Determine number of keywords included in category databases (for example, databases in “Dataset 1”will contain 60 public keywords).

Step 3.

Mirror public category databases with searchable private category databases (“Dataset 2”=7 simple searchable private databases).

Step 4.

Determine the number of searchable private keywords included in searchable category databases (for example, databases in “Dataset 2” contain 30 searchable keywords). These keywords are different from public keywords and will be used to characterize user's raw search patterns.

Step 5.

Create an additional database (“Dataset 3”), which contains 60 generic public keywords.

Step 6.

Develop a user cookie that does the following:

a.) When users search on the search engine the first time, the cookie looks at (“Data-Set 2”) and assigns an user ID and database number 1-7 based on which database of searchable private keywords is most relevant to the user's search activity during that session. (In cases where relevancy is equal, the cookie will assign the ID and database number 1-7 in the ascending order of the databases.)

b.) If the search term(s) does not match any of the keywords during the session, the cookie should assign a 0 value (0 equates to “Data-Set 3”).

Step 7.

a.) The next time the user visits the site, The cookie will be identified based on the associated ID and database number (1-7) and all 60 keywords from the associated database (1-7) in “Data-Set 1” is fetched and populated into a pre-defined JavaScript array that randomly rotates keywords in the search box.

b.) For users with no cookie (either first time users or users that have removed the cookie from their computer), the program will fetch all 60 keywords from “Data-Set 3”and populate them into the pre-defined JavaScript array.

c.) Each time the user searches on the search engine, the database number 1-7 will be updated if the user search activity during that session generates a different database number (1-7).

1. I claim that this is a new and unique process to pre-populate search suggestions within search results.

2. I claim that the “Intelli-Match” technical process is a unique way of assisting consumers in searching the Internet.
